(19) United States
(12) Patent Application Publication
(10) Pub. No.: US 2026/0188670 A1
(43) Pub. Date: Jul. 2, 2026

(54) SOLID-STATE BATTERY

(71) Applicant: TOYOTA JIDOSHA KABUSHIKI KAISHA, Toyota-shi (JP)

(72) Inventors: Hiroo NOZAKI, Chiryu-shi (JP); Ryo ASAKURA, Sunto-gun (JP); Shinya SHIOTANI, Nagoya-shi (JP)

(73) Assignee: TOYOTA JIDOSHA KABUSHIKI KAISHA, Toyota-shi (JP)

(21) Appl. No.: 19/311,338

(22) Filed: Aug. 27, 2025

(30) Foreign Application Priority Data
Dec. 27, 2024 (JP) 2024-232989

(51) Int. Cl. H01M 4/58; H01M 4/02; H01M 4/38; H01M 10/0562

(52) U.S. Cl. CPC H01M 4/5815; H01M 4/382; H01M 10/0562; H01M 2004/025

(57) ABSTRACT

A solid-state battery includes a cathode layer including a cathode active material containing sulfur, an anode layer including an anode active material containing lithium, and a solid electrolyte layer disposed between the cathode layer and the anode layer, in which the cathode layer includes a plurality of columnar structures laid out distanced from each other, a value of an aspect ratio [β/α] calculated from a radial dimension α of a face of each of the columnar structures in contact with the solid electrolyte layer and a dimension β of each of the columnar structures in a thickness direction of the cathode layer is equal to or more than 2, and is equal to or less than an aspect ratio at which a buckling stress calculated by Euler's buckling formula for each of the columnar structures is greater than a stress due to a constraining pressure applied to the columnar structures.

### CROSS-REFERENCE TO RELATED APPLICATION

This application claims priority to Japanese Patent Application No. 2024-232989 filed on Dec. 27, 2024. The disclosure of the above-identified application, including the specification, drawings, and claims, is incorporated by reference herein in its entirety.

### BACKGROUND

### 1. Technical Field

The present disclosure relates to a solid-state battery.

### 2. Description of Related Art

In recent years, secondary batteries have become increasingly important, and in addition to secondary batteries containing electrolytic solution, development of solid-state batteries using solid electrolytes are underway. All-solid-state batteries, which are an example of solid-state batteries, are batteries that have a solid electrolyte layer instead of an electrolytic solution, and safety devices can be simplified since flammable organic solvents are not used, and manufacturing costs and productivity thereof are excellent. Japanese Unexamined Patent Application Publication No. 2018-026199 (JP 2018-026199 A) and Japanese Unexamined Patent Application Publication No. 2003-123840 (JP 2003-123840 A) disclose a so-called LiS battery that is a type of solid-state battery that uses sulfur (S) as a cathode active material and that uses lithium (Li) as an anode active material. LiS batteries have attracted attention as solid-state batteries that realize both high energy density and low costs.

However, several technical problems have been pointed out regarding LiS batteries. According to JP 2018-026199 A, a problem with LiS batteries is that sulfur, which is the cathode active material, expands and contracts with charging and discharging, causing ionic conduction and electronic conduction paths to be interrupted. With respect to this point, JP 2018-026199 A discloses a method in which sulfur and Li₂S are mixed at a predetermined ratio, when preparing a cathode composite material for a LiS battery. It is said that by mixing Li₂S into the cathode composite material, the effects of expansion and contraction of the active material can be mitigated from the first charge and discharge. Also, J P 2003-123840 A discloses a problem that in LiS batteries, sulfur dissolves into the electrolyte during oxidation-reduction reaction, shortening the battery life, and in a case in which an appropriate electrolytic solution is not selected, Li₂S, which is a sulfur reduction substance, becomes deposited and is no longer able to contribute to electrochemical reaction.

### SUMMARY

However, in a solid-state battery including a cathode layer including a cathode active material containing sulfur, an anode layer containing an anode active material containing lithium, and a solid electrolyte layer laid out between the cathode layer and the anode layer, the cathode active material containing sulfur expands and contracts during charging and discharging, thereby generating large internal stress in a direction perpendicular to a lamination direction of the cathode layer, the solid electrolyte layer, and the anode layer, causing cracks in the solid electrolyte layer, and leading to problems such as short-circuiting occurring and reduced rate characteristics due to damage to conduction paths.

In view of the above-described circumstances, it is an object of the present disclosure to provide a solid-state battery that includes a cathode layer that can mitigate stress that is generated in a cathode layer due to expansion and contraction of cathode active material, and that can suppress occurrence of cracks in a solid electrolyte layer.

In order to achieve the above-described object, the present inventors conducted intensive research, and consequently found that when a cathode layer includes a plurality of columnar structures having a predetermined aspect ratio, stress caused by expansion and contraction of a cathode active material can be mitigated, whereby cracking of the solid electrolyte layer can be suppressed, and accordingly have completed the present disclosure. The present disclosure encompasses the following.
<1> A solid-state battery including a cathode layer including a cathode active material containing sulfur, an anode layer including an anode active material containing lithium, and a solid electrolyte layer that is laid out between the cathode layer and the anode layer, in which the cathode layer includes a plurality of columnar structures laid out at a distance from each other, a value of an aspect ratio [β/α] that is calculated from a radial dimension α of a face of each of the columnar structures that is in contact with the solid electrolyte layer and a dimension β of each of the columnar structures in a thickness direction of the cathode layer is equal to or more than 2, and also is equal to or less than an aspect ratio at which a buckling stress that is calculated by Euler's buckling formula for each of the columnar structures is greater than a stress due to a constraining pressure that is applied to the columnar structures.
<2> The solid-state battery according to <1>, in which a cross-sectional shape of the columnar structures is such that the radial dimension decreases toward faces of the columnar structures that are in contact with the solid electrolyte layer.
<3> The solid-state battery according to <1> or <2>, in which the columnar structures are in contact with each other on an opposite side from the faces that are in contact with the solid electrolyte layer.
<4> The solid-state battery according to any one of <1> to <3>, in which the columnar structures are disposed in a concentric, lattice, or honeycomb pattern.
<5> The solid-state battery according to any one of <1> to <4>, in which the cathode layer includes a solid electrolyte containing sulfur and phosphorus.

In the solid-state battery according to the present disclosure, stress that is generated in the cathode layer following repeated charging and discharging can be mitigated, and occurrence of cracking in the solid electrolyte layer can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of a primary portion of a solid-state battery according to an embodiment of the present disclosure;

FIG. 2A is a main-portion perspective view schematically illustrating columnar structures in the solid-state battery according to the embodiment of the present disclosure;

FIG. 2B is a main-portion perspective view schematically illustrating columnar structures in the solid-state battery according to the embodiment of the present disclosure;

FIG. 2C is a main-portion perspective view schematically illustrating columnar structures in the solid-state battery according to the embodiment of the present disclosure;

FIG. 3A is a schematic diagram of a columnar structure, for explanation of an aspect ratio that is calculated for the columnar structure;

FIG. 3B is a schematic diagram of a columnar structure for explaining an aspect ratio that is calculated for the columnar structure; and

FIG. 4 is a cross-sectional view of a primary portion of a solid-state battery according to another embodiment of the present disclosure.

### DETAILED DESCRIPTION OF EMBODIMENTS

A solid-state battery according to the present disclosure includes a cathode layer including a cathode active material containing sulfur, an anode layer including an anode active material containing lithium, and a solid electrolyte layer that is disposed between the cathode layer and the anode layer, in which the cathode layer includes a plurality of columnar structures laid out at distances from each other. In the solid-state battery according to the present disclosure, a value of an aspect ratio [β/α] that is calculated from a radial dimension α of a face of the columnar structure in contact with the solid electrolyte layer and a dimension β of the columnar structure in a thickness direction of the cathode layer is equal to or greater than 2, and also is equal to or less than an aspect ratio at which buckling stress of the columnar structure that is calculated by Euler's buckling formula is greater than stress due to constraining pressure that is applied to the columnar structure.

In the solid-state battery according to the present disclosure, the cathode layer includes the columnar structures that are laid out at distances from each other, and the shape of the columnar structures is specified to have the above-mentioned aspect ratio. Thus, according to the solid-state battery of the present disclosure, even when the cathode active material that contains sulfur repeatedly expands and contracts during charging and discharging, the stress that is generated in the cathode layer can be mitigated, and cracking of the solid electrolyte layer can be suppressed. This is presumably because, due to intervals that are formed among the columnar structures, expansion of the cathode active material, i.e., expansion of the columnar structures, is absorbed by these intervals, and as a result, the stress that is generated in the cathode layer is mitigated.

Here, Euler's buckling formula is given by the following Expression for buckling stress σ.

$$σ = n {π}^{2} E / λ {l}^{2} \qquad Expression$$

In the above Expression, n is a terminal condition coefficient, and when both ends are fixed as in the case of the columnar structures, n=4 holds. In the above Expression, R represents the circumferential ratio (3.14), and E represents the modulus of longitudinal elasticity, i.e., Young's modulus. In the above Expression, λ is the aspect ratio of the columnar structure (the above [β(μm)/α(μm)]), and l is a length β(μm) of the columnar structure.

By setting the aspect ratio of the columnar structures to 2 or more in the solid-state battery of the present disclosure, even when the columnar structures expand as described above, the expansion is absorbed by the intervals among the columnar structures, and occurrence of cracks in the solid electrolyte layer can be suppressed. In particular, the aspect ratio of the columnar structure is preferably 2.5 or more, more preferably 3 or more, even more preferably 3.5 or more, and even more preferably 4 or more. Furthermore, the upper limit of the aspect ratio of the columnar structure is defined such that buckling stress is greater than constraining pressure that is applied to the columnar structure, as described above. This allows the columnar structure to maintain its shape without buckling, even in a state in which the constraining pressure is applied to the columnar structure. Note that the constraining pressure is a pressure that is applied in a laminating direction of a laminate including a cathode layer, a solid electrolyte layer, and an anode layer, and is, for example, a pressure that is applied to the laminate by a constraining member or a pressure applied by accommodating the laminate inside an outer encasement.

More specifically, the upper limit of the aspect ratio of the columnar structure is calculated as a value dependent on the dimension β of the columnar structure, the Young's modulus of the cathode active material, and the constraining pressure, as can be seen from the above-described Euler's buckling formula. For example, when the constraining pressure is 1 MPa, the Young's modulus of sulfur in the cathode active material layer is 10 GPa, and the dimension β of the columnar structure is 78 μm, it can be calculated that buckling will occur when the aspect ratio is 64.89 or higher. In this case, the upper limit of the aspect ratio can be set to 64 or lower. Note, however, that the upper limit of the aspect ratio is not limited to 64 or lower and can be, for example, 60 or lower, preferably 50 or lower, more preferably 40 or lower, and even more preferably 30 or lower.

Here, the columnar structure may have any shape, such as a circular cylinder, a polygonal prism, a truncated cone, a truncated polygonal pyramid, or the like. In particular, when the columnar structure has a shape of a polygonal prism or a truncated polygonal pyramid, the corners in a cross-section are preferably not acute angles (i.e., obtuse angles), and thus the columnar structure preferably has a polygonal prism or a truncated polygonal pyramid of which the number of corners is equal to or greater than the number of corners of a quadratic prism or a square truncated pyramid. By making the columnar structure into a cylinder, a truncated cone, a polygonal prism of which the number of corners is equal to or greater than a quadratic prism, or a truncated polygonal pyramid of which the number of corners is equal to or greater than the number of corners of a square truncated pyramid, the mechanical strength is increased, thereby enabling cracking or the like, due to expansion and contraction of the columnar structure during charging and discharging, to be suppressed. Note that these columnar structures can be formed by, for example, forming a cathode layer containing cathode active material into a layered form, which is then subjected to laser processing or some other such method.

The face of the columnar structure that is in contact with the solid electrolyte layer is circular or polygonal, differing depending on the shape of the columnar structure, such as a cylinder, a polygonal prism, a truncated cone, a truncated polygonal pyramid, or the like. The radial dimension α of the face of the columnar structure that is in contact with the solid electrolyte layer can be the diameter when the face is circular, can be a dimension of a major axis or an average dimension of the major axis and a minor axis when the face is elliptical, or can be a dimension of a maximum length within the face or an average dimension of the maximum length and the minimum length within the face when the face is polygonal.

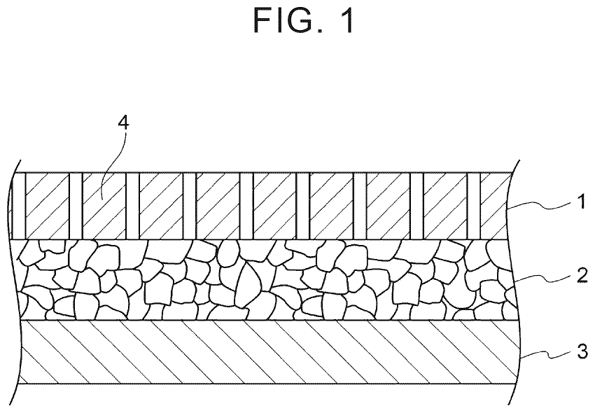

FIG. 1 illustrates an embodiment of a laminate including a cathode layer, a solid electrolyte layer, and an anode layer, in the solid-state battery according to the present disclosure. As illustrated in FIG. 1, the laminate making up the solid-state battery of the present disclosure includes a cathode layer 1, a solid electrolyte layer 2, and an anode layer 3. Although omitted from illustration, a cathode current collector is provided on a face of the cathode layer 1 that is opposite to a face of contact with the solid electrolyte layer 2, and an anode current collector is provided on a face of the anode layer 3 opposite to a face of contact with the solid electrolyte layer 2. In particular, in the laminate making up the solid-state battery of the present disclosure, the cathode layer 1 has the columnar structures 4 that are laid out at a distances from each other. While a cross-section of the laminate in this example is illustrated in FIG. 1, the shape of the laminate as viewed in top view is not limited in particular, and may be any shape such as a circle, a rectangle, a polygon, or the like.

The columnar structures 4 may be laid out randomly or may be laid out with regularity. In particular, the intervals among the columnar structures 4 that are adjacent is preferably approximately equal among the columnar structures 4. For the intervals among the columnar structures 4 that are adjacent to be approximately equal means that the closest distances among the upper end faces of columnar structures 4 in closest proximity are approximately equal. “Approximately equal distances” means that the difference between the greatest distance and the smallest distance is within 25%, preferably within 20%, more preferably within 15, and even more preferably within 10%. By making the intervals between the columnar structures 4 that are adjacent to be approximately equal, localized increase in internal stress due to expansion of the columnar structures 4 can be suppressed, and stress over the entire cathode layer 1 can be mitigated.

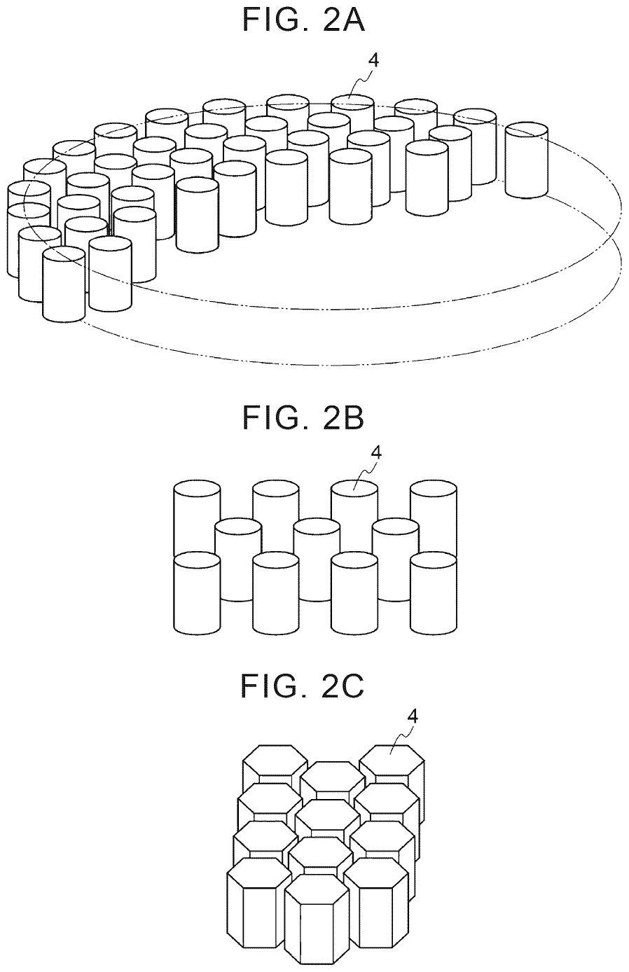

Examples of the columnar structures 4 that are laid out with regularity include those illustrated in FIGS. 2A, 2B and 2C. In the example illustrated in FIG. 2A, the columnar structures 4 are each cylindrical, and are disposed in a plurality of concentric rows. In the example illustrated in FIG. 2B, the columnar structures 4 are each cylindrical, and are disposed in a lattice pattern. In the example illustrated in FIG. 2C, the columnar structures 4 are each a hexagonal column, and are disposed in a honeycomb pattern. In any of these cases, localized increase in internal stress due to expansion of the columnar structures 4 can be suppressed since the columnar structures 4 are laid out regularly, and stress over the entire cathode layer 1 can be mitigated.

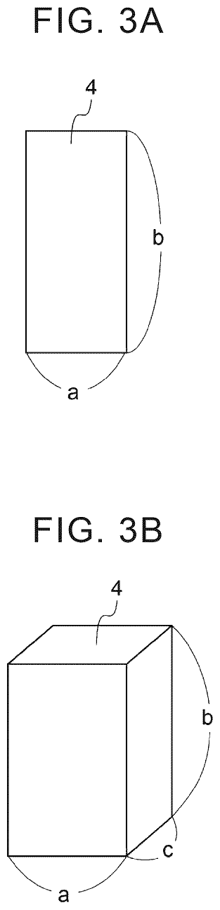

As described above, the aspect ratio of the columnar structure 4 is calculated by [β/α], where α is the radial dimension of the face of the columnar structure 4 in contact with the solid electrolyte layer 2, and β is the dimension of the columnar structure 4 in the thickness direction of the cathode layer 1. More specifically, in the columnar structure 4 that is a cylinder or a polygonal prism, as illustrated in FIG. 3A, a dimension α corresponds to the radial dimension α, and a dimension b corresponds to the dimension β. Also, as illustrated in FIG. 3B, when the columnar structure 4 is a quadratic prism having a rectangular cross-section, a diagonal line of a rectangle that is formed by side a and side c is defined as the radial dimension α. Note that in this case as well, the dimension b corresponds to the dimension β.

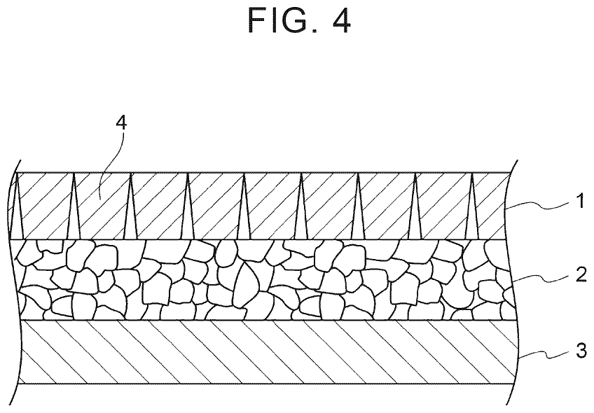

Also, in the solid-state battery of the present disclosure, the columnar structure 4 preferably has a cross-sectional shape in which the radial dimension decreases toward the face that is in contact with the solid electrolyte layer 2. An example of the columnar structure 4 having a cross-sectional shape in which the radial dimension decreases toward the face that is in contact with the solid electrolyte layer 2 is a columnar structure 4 in the form of a truncated cone or a truncated polygonal pyramid, as illustrated in FIG. 4. When the columnar structures 4 have a cross-sectional shape in which the radial dimension decreases toward the face that is in contact with the solid electrolyte layer 2, even when the columnar structures 4 repeatedly expand and contract during charging and discharging, stress can be mitigated in the region of the cathode layer 1 close to the solid electrolyte layer 2, and the occurrence of cracking in the solid electrolyte layer 2 can be suppressed in a sure manner.

Furthermore, in the solid-state battery according to the present disclosure, the columnar structures 4 are preferably in contact with each other at the face opposite to the face that is in contact with the solid electrolyte layer 2. In other words, the columnar structures 4 are at distances from each other on the face that is in contact with the solid electrolyte layer 2, and the intervals therebetween gradually narrow toward the face opposite to the face that is in contact with the solid electrolyte layer 2, and are in contact with each other on the face opposite to the face in contact with the solid electrolyte layer 2. Examples of the shape of the columnar structures 4 in contact with each other on the face opposite to the face that is in contact with the solid electrolyte layer 2 include columnar structures 4 in the form of a truncated cone or a truncated polygonal pyramid as illustrated in FIG. 4. Note that while the columnar structures 4 illustrated in FIG. 4 are in contact with each other on the face opposite to the face that is in contact with the solid electrolyte layer 2, the solid-state battery according to the present disclosure is not limited to this configuration. In the solid-state battery according to the present disclosure, the columnar structures 4 may be in contact with each other up to 1/10 of height in the thickness direction of the cathode layer 1 from the face opposite to the face that is in contact with the solid electrolyte layer 2, preferably ⅕ of the height, and more preferably ⅓ of the height. Such cases are also included in a form of being in contact with each other at the face opposite to the face in contact with the solid electrolyte layer 2. Configuring the columnar structures 4 to be in contact with each other at the face opposite to the face in contact with the solid electrolyte layer 2, enables the volume of the columnar structures 4 to be increased, and the battery performance can be improved. Also, in this case, the solid electrolytes repel each other, and stress in a direction orthogonal to the laminating direction can be reduced.

The elements of the solid-state battery of the present disclosure that is configured as above will be described below. However, the technical scope of the solid-state battery of the present disclosure is not limited to the following description.

### Cathode Active Material

In the solid-state battery according to the present disclosure, the cathode layer contains sulfur as a cathode active material. The cathode layer contains at least sulfur as a cathode active material, and may further optionally contain an electrolyte, a conductive aid, a binder, and so forth. The cathode layer may further contain various types of additives. The content of each component in the cathode layer may be determined as appropriate in accordance with the intended battery performance. For example, with the entire cathode layer (total solid content) as 100% by mass, the content of the cathode active material may be 10% by mass or more, 20% by mass or more, 30% by mass or more, 40% by mass or more, 50% by mass or more, 60% by mass or more, or 70% by mass or more, and may be 100% by mass or less, or 90% by mass or less. The thickness of the cathode layer is not limited in particular, and may be, for example, 0.1 μm or more, 1 μm or more, or 10 μm or more, and may be 2 mm or less, 1 mm or less, or 500 μm or less.

For the cathode active material, at least sulfur is used, as described above. It is sufficient for the sulfur to be any sulfur that can function as a cathode active material, and may be elemental sulfur, or may be a sulfur compound. For example, the cathode active material may be elemental sulfur. Examples of elemental sulfur include S₈ sulfur. S₈ sulfur has three crystal forms, which are α sulfur (orthorhombic sulfur), β sulfur (monoclinic sulfur), and γ sulfur (monoclinic sulfur), and any of these crystal forms may be used. The amount of the cathode active material that is contained in the cathode layer is not limited in particular, and may be determined as appropriate in accordance with the intended battery performance. For example, the cathode layer may contain 10% by mass to 80% by mass of the cathode active material. The lower limit of the content of the cathode active material may be 15% by mass or more, 20% by mass or more, or 25% by mass or more. The upper limit of the content of the cathode active material may be 70% by mass or less, or may be 60% by mass or less.

Part or all of the cathode active material may be dissolved in a sulfur-containing compound, which will be described later. In other words, the cathode layer may contain a solid solution of the cathode active material and the sulfur-containing compound. Also, the sulfur in the cathode active material and the sulfur in the sulfur-containing compound may have a chemical bond (S—S bond). Examples of the sulfur-containing compound include a boron-containing sulfur compound containing boron and sulfur, and a phosphorus-containing sulfur compound containing phosphorus and sulfur. For the sulfur compound, either or both of a boron-containing sulfur compound and a phosphorus-containing sulfur compound can be used. Note that the cathode layer may contain just the cathode active material and the sulfur-containing compound, or may further contain other elements (e.g., Ge, Sn, Si, or Al) and so forth.

In the cathode layer, the sulfur-containing compound can assume various forms. For example, the cathode layer may contain a sulfur-containing compound having an ortho-composition structure. That is to say, a sulfur-containing compound having boron and sulfur may have an ortho structure of boron. The ortho structure of boron is specifically a BS₃ structure. Also, a sulfur-containing compound having phosphorus and sulfur may have an ortho structure of phosphorus. The ortho structure of phosphorus is specifically a PS₄ structure. The sulfur-containing compound may also have an ortho structure of an M element (M is, for example, Ge, Sn, Si, or Al). Examples of the ortho structure of the M element include a GeS₄ structure, an SnS₄ structure, an SiS₄ structure, and an AlS₃ structure. Further, the cathode composite material may contain a sulfide as a sulfur-containing compound. That is to say, the sulfur-containing compound having boron and sulfur may have a sulfide of boron (B₂S₃). On the other hand, the sulfur-containing compound having phosphorus and sulfur may have a phosphorus sulfide (e.g., P₂S₅). Also, the sulfur-containing compound may also have a sulfide of the M element (MₓS_{y}). Here, x and y are integers that impart electrical neutrality with S, in accordance with the type of M. Examples of sulfides (MₓS_{y}) include GeS₂, SnS₂, SiS₂, and Al₂S₃. These sulfides may also be, for example, residues of starting materials.

The cathode layer may contain a cathode active material other than elemental sulfur and sulfur compounds. Examples of cathode active materials other than elemental sulfur and sulfur compounds include various types of lithium-containing compounds. The lithium-containing compound may be any of various types of lithium-containing oxides, such as lithium cobaltate, lithium nickelate, Li_{1±α}Ni_{1/3}Co_{1/3}Mn_{1/3}O_{2±δ}, lithium manganate, spinel-based lithium compounds (such as Li—Mn spinel or the like substituted with different elements having a composition that is represented by Li₁₊ₓMn_{2-x-y}M_{y}O₄ (where M is one or more selected from Al, Mg, Co, Fe, Ni, and Zn)), lithium titanate, lithium metal phosphate (such as LiMPO₄ or the like, where M is one or more selected from Fe, Mn, Co, and Ni), and so forth.

The cathode active material may have any shape as long as it is a general shape for a cathode active material in a lithium-sulfur battery. The cathode active material may be, for example, in the form of particles. The cathode active material may be solid, may be hollow, may have voids, or may be porous. The cathode active material may be in the form of primary particles or secondary particles formed by aggregation of a plurality of primary particles. The average particle diameter D50 of the cathode active material may be, for example, 1 nm or more, 5 nm or more, or 10 nm or more, and may be 500 μm or less, 100 μm or less, 50 μm or less, or 30 μm or less. Note that the average particle diameter D50 referred to in the present application is a particle diameter (median diameter) at an integrated value of 50% in a volume-based particle size distribution determined by a laser diffraction/scattering method.

The electrolyte that can be contained in the cathode layer may be a solid electrolyte, a liquid electrolyte (electrolytic solution), or a combination thereof. In particular, when the cathode layer contains at least a solid electrolyte as the electrolyte, a higher effect is more readily obtained. The solid electrolyte may be any known solid electrolyte for batteries. The solid electrolyte may be an inorganic solid electrolyte or an organic polymer electrolyte, which will be described below. The electrolytic solution can include lithium ions. The electrolytic solution may be, for example, a non-aqueous electrolytic solution. It is sufficient for the composition of the electrolytic solution to be the same as that of a known electrolytic solution for a battery. For example, a carbonate-based solvent having a lithium salt dissolved therein at a predetermined concentration can be used as the electrolytic solution. Examples of carbonate-based solvents include fluoroethylene carbonate (FEC), ethylene carbonate (EC), dimethyl carbonate (DMC), and so forth. Examples of lithium salt include LiPF6 and so forth.

Examples of the conductive aid that can be contained in the cathode layer include carbon materials such as vapor grown carbon fiber (VGCF), acetylene black (AB), Ketjen black (KB), carbon nanotubes (CNT), carbon nanofibers (CNF), and so forth; and metal materials such as nickel, aluminum, stainless steel, and so forth. The conductive aid may be, for example, in the form of particles or fibers, and the size thereof is not limited in particular. Just one type of conductive aid may be used alone, or two or more types may be used in combination.

Examples of binders that can be included in the cathode layer include butadiene rubber (BR)-based binders, butylene rubber (IIR)-based binders, acrylate butadiene rubber (ABR)-based binders, styrene butadiene rubber (SBR)-based binders, polyvinylidene fluoride (PVdF)-based binders, polytetrafluoroethylene (PTFE)-based binders, polyimide (PI)-based binders, and so forth. Just one type of binder may be used alone, or two or more types thereof may be used in combination.

### Solid Electrolyte

As for the solid electrolyte, any inorganic solid electrolyte that is generally used in solid-state batteries can be used without any limitation. As such an inorganic solid electrolyte, crystalline nitrides, oxides, sulfides and oxoacid salts, as well as non-crystalline glass-structured materials can be used. Specifically, a sulfide solid electrolyte that can be used as the solid-state electrolyte may be at least one type selected from a group consisting of, for example, LiI—LiBr—Li₃PS₄, Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—P₂S₅, Li₃PS₄, LiCl—LiBr—Li₃PS₄, LiCl—LiBr—Li₂S—P₂S₅, and LiCl—LiBr—Li₂S—SiS₂. Also, examples of oxide-based solid electrolytes include Li_{0.34}La_{0.56}TiO₃, Li_{3/8}Sr_{7/16}Ta_{3/4}M_{1/4}O₃ (M=Zr or Hf), Li₇La₃Zr₂O₁₂, Li_{1.3}Al_{0.7}Ti_{1.3}(PO₄)₃, Li_{1.5}Al_{0.5}Ge_{1.5}(PO₄)₃, Li_{3.5}Ge_{0.5}V_{0.5}O, Li_{2.88}PO_{3.73}N_{0.14}, and Li_{2.9}Si_{0.45}PO_{1.6}N_{1.3}. In addition to these, complex hydride-based lithium-ion conductors and halide-based lithium-ion conductors may also be used as solid electrolytes.

### Anode Active Material

In the solid-state battery according to the present disclosure, the anode layer includes an anode active material. In the solid-state battery according to the present disclosure, the anode active material is not limited in particular. The anode layer contains at least an anode active material, and may further optionally contain an electrolyte, a conductive aid, a binder, and so forth. Lithium, for example, is used as the anode active material. It is sufficient for the lithium to be any lithium that can function as an anode active material, and may be metallic lithium, a lithium alloy, or a lithium compound. Also, the anode active material layer may contain an anode active material other than lithium. Examples of anode active materials other than lithium include Si-based active materials such as Si, Si alloys, Si compounds, and so forth, and carbon-based active materials such as graphite and so forth. The electrolyte, the conductive aid, and the binder that can be contained in the anode layer can be appropriately selected and used from those exemplified as those that can be contained in the cathode layer. The electrolyte, the conductive aid, and the binder that is contained in the anode layer, and the electrolyte, the conductive aid, and the binder that is contained in the cathode layer may be of the same type or of different types.

### Other Configurations

The solid-state battery according to the present disclosure may include, in addition to the cathode layer including the above-described cathode active material, the above-described solid electrolyte layer, and the anode layer including the above-described anode active material, a cathode current collector, an anode current collector, an outer encasement, a sealing resin, constraining members, and so forth. There are no limitations in particular on the cathode current collector, the anode current collector, the outer encasement, the sealing resin, and the constraining members, and materials, shapes, configurations, and so forth thereof, can be optionally selected.

The solid-state battery according to the present disclosure includes all-solid-state batteries using a solid electrolyte as an electrolyte, semi-solid-state batteries having a gel layer containing an electrolytic solution and a polymer between an electrode and a solid electrolyte, and so forth, and all-solid-state batteries are preferred.

### Fabrication of Solid-State Battery

In the present disclosure, a laminate having a solid electrolyte layer, a cathode layer, and an anode layer can be fabricated by a conventionally known method using the above-described solid electrolyte, active materials, and other components, as materials, and thereby manufacture a solid-state battery. The solid electrolyte layer, the cathode layer, and the anode layer may be formed by, for example, a dry film formation that does not use a solvent, or may be formed by wet film formation that uses a solvent. In the dry film formation, the materials making up each layer may be mixed and pressed to produce the layer, for example. Also, in the dry film formation, the materials making up each layer may be dispersed in a dispersant to form a slurry, and then the slurry may be applied to a predetermined substrate and dried to produce an electrode.

As an example of a method for producing a cathode layer using a slurry, first, a cathode active material, a solid electrolyte, a conductive aid, and so forth are stirred and mixed in a solvent (also called a dispersion medium) to prepare a slurry. Examples of the solvent include, but are not limited to in particular, 1,2,3,4-tetrahydronaphthalene, butyl acetate, butyl butyrate, mesitylene, tetralin, heptane, N-methyl-2-pyrrolidone (NMP), and so forth. The slurry that is obtained is then applied to a substrate, such as a cathode current collector or the like, by a conventionally known method. The substrate to which the slurry is applied is not limited in particular, and may be a metal foil, a cathode current collector, or a solid electrolyte layer. The coating method can be carried out by a known method. Examples include common methods such as the doctor blade method, die coating, gravure coating, spray coating, electrostatic coating, bar coating, and so forth.

Next, the slurry that is applied to a substrate, such as the cathode current collector or the like, is dried. At this time, the slurry may be heated to a temperature in a range of 50° C. to 200° C. or less, and the atmosphere may be set to an inert atmosphere or a reduced pressure atmosphere. Thereafter, the columnar structures are fabricated by laser processing. After laminating the cathode layer having the columnar structures, the solid electrolyte layer, and the anode layer, constraining thereof may be performed by constraining members. The laminate then can be accommodated in an outer encasement to manufacture the solid-state battery according to the present disclosure.

Hereinafter, the solid-state battery according to the present disclosure will be described with reference to Examples, but the technical scope of the present disclosure is not limited to the following Examples.

### Example 1, Comparative Example 1, and Comparative Example 2

For the cathode composite material that is used in Example 1, Comparative Example 1, and Comparative Example 2, an S—P₂S₅—C composite material was prepared. First, sulfur (vacuum-dried at 80° C.), P₂S₅ and single-walled carbon nanotubes were mixed in a mortar at a weight ratio of 42:35:23, and the mixture was stirred and mixed in a planetary ball mill for a total of 36 hours. Thereafter, the mixture was classified by dry classifying using a 38 μm sieve to obtain an S—P₂S₅—C composite material for the cathode. The S—P₂S₅—C composite material that was obtained was kneaded with a binder and a solvent to prepare a slurry, and the slurry was applied to a cathode current collector to fabricate a cathode layer.

For the cathode layer that was used in the solid-state battery according to Example 1, columnar structures was formed using an ultrashort pulse laser, such that the aspect ratio [β/α] calculated from the radial dimension α of the face that was in contact with the solid electrolyte layer and the dimension β of the cathode layer in the thickness direction was 2. In this example, multiple columnar structures were formed so as to be disposed concentrically upon the cathode layer, which was circular in top view (FIG. 2A). Also, a cathode layer that was used in the solid-state battery of Comparative Example 1 was not patterned (aspect ratio [β/α]=1/144.6). Further, the cathode layer that was used in the solid-state battery according to Comparative Example 2 was processed in the same manner as in Example 1, such that the aspect ratio [β/α] was 1.

Also, for the solid electrolyte that was used in Example 1, Comparative Example 1, and Comparative Example 2, a Li₂S—P₂S₅-based material containing a halogen was prepared as a sulfide solid electrolyte. A mixture of this sulfide solid electrolyte, a binder, and a solvent was then prepared. This mixture was applied onto a release film. The mixture that was applied was then dried. After drying, the release film was peeled off to obtain a solid electrolyte layer.

Further, for the anode layer that was used in Example 1, Comparative Example 1, and Comparative Example 2, a Li—Mg alloy layer was formed on a Ni foil serving as an anode current collector.

A test cell was fabricated by laminating the cathode layer, the solid electrolyte layer, and the anode layer, that were thus obtained, and the following charging/discharging test was carried out. In the charging/discharging test, a constant current density of 0.584 mA/cm² (corresponding to 0.1 C where 1 C=5.84 mA/cm²) was applied to the test cell that was fabricated, with a cutoff lower limit voltage of 1.2 V. The charging/discharging test was carried out at 60° C. After the charging-discharging test, the test cells of Example 1, Comparative Example 1, and Comparative Example 2 were cut parallel to the lamination direction, and the number of cracks that were observed on the cut face of the solid electrolyte layer was counted. The results thereof are shown in Table 1.

TABLE 1

| | | Comparative | Comparative |
|---|---|---|---|
| | Example 1 | Example 1 | Example 2 |
| Aspect Ratio | 2 | 1/144.6 | 1 |
| Number of cracks | 0 | 118 | 17 |

As shown in Table 1, in the test cell of Comparative Example 1, many cracks were observed on the cut face. This is presumably because the cathode layer, which contains the cathode active material containing sulfur, repeatedly expands and contracts during charging and discharging, causing stress to be applied to the solid electrolyte layer. In contrast, in the test cell of Example 1, no cracks were formed on the cut face of the solid electrolyte layer. This is presumably because the stress that was caused by the expansion and contraction of the cathode layer accompanying charging and discharging was mitigated, and the solid electrolyte layer was not subjected to a level of stress that would cause cracks. Also, in Comparative Example 1, cracks occurred on the cut face of the solid electrolyte layer, which revealed that when the aspect ratio [β/α] of the columnar structures formed in the cathode layer is 2 or more, the formation of cracks in the solid electrolyte layer can be suppressed in a sure manner.

What is claimed is:

1. A solid-state battery comprising:
a cathode layer including a cathode active material containing sulfur; an anode layer including an anode active material containing lithium; and a solid electrolyte layer that is laid out between the cathode layer and the anode layer, wherein
the cathode layer includes a plurality of columnar structures laid out at a distance from each other, a value of an aspect ratio [β/α] that is calculated from a radial dimension α of a face of each of the columnar structures that is in contact with the solid electrolyte layer and a dimension β of each of the columnar structures in a thickness direction of the cathode layer is equal to or more than 2, and also is equal to or less than an aspect ratio at which a buckling stress that is calculated by Euler's buckling formula for each of the columnar structures is greater than a stress due to a constraining pressure that is applied to the columnar structures.

2. The solid-state battery according to claim 1, wherein a cross-sectional shape of the columnar structures is such that the radial dimension decreases toward faces of the columnar structures that are in contact with the solid electrolyte layer.

3. The solid-state battery according to claim 1, wherein the columnar structures are in contact with each other on an opposite side from the faces that are in contact with the solid electrolyte layer.

4. The solid-state battery according to claim 1, wherein the columnar structures are disposed in a concentric, lattice, or honeycomb pattern.
